(19) United States
(12) Patent Application Publication
(10) Pub. No.: US 2017/0030083 A1
(43) Pub. Date: Feb. 2, 2017

(54) PRIVACY AND WEATHER PROTECTION BARRIER

(71) Applicant: Vito Matturro, Nutley, NJ (US)

(72) Inventor: Vito Matturro, Nutley, NJ (US)

(21) Appl. No.: 15/225,058

(22) Filed: Aug. 1, 2016

Related U.S. Application Data
(60) Provisional application No. 62/199,369, filed on Jul. 31, 2015.

(51) Int. Cl. E04F 10/02; F16M 13/02; E06B 9/24; E04H 17/00

(52) U.S. Cl. CPC E04F 10/02; E04H 17/00; F16M 13/02; E06B 9/24

(57) ABSTRACT

A portable awning to enhance the privacy of and protected a given area from the elements may have at least two support members, a first length of material coupled to and spanning a distance between the at least two support members, and a wind barrier made up of at least two layers, where the at least two layers are formed from the first layer of material and a mesh layer. This portable awning can be affixed to existing structures rising from the ground such as a fence or pole. The portable awning is intended to provide protection from the elements such as wind, rain, sunlight, and the like. It can also provide a source of shade, as well as privacy for a particular piece of property.

### CLAIM OF PRIORITY

This application claims priority to U.S. Application Ser. No. 62/199,369 filed on Jul. 31, 2015, the contents of which are herein incorporated by reference in its entirety.

### FIELD OF THE EMBODIMENTS

The field of the invention and its embodiments relate to barriers that can be used to mitigate the effects of the environment and provide an additional layer of privacy. In particular, a barrier may comprise an angled awning that has an optional wind barrier. The barrier may be positioned as a standalone item or in conjunction with an existing structure such as a fence, barricade, or the like.

### BACKGROUND OF THE EMBODIMENTS

Removable and/or permanent barriers are often found to border and define property lines, especially in highly populated urban areas. Further, such barriers provide an element of privacy over congested areas and can provide a more serene environment to a piece of property. Even still some barriers may be helpful in preventing the effects of the environment such as sun light, wind, rain, and the like from being felt by the occupants. While various barriers can provide some privacy and weather shielding effects, these barriers leave a lot to be desired.

In many locations there are laws or covenants that govern the particular appearance and/or height of such barriers. For example, some barriers may become unstable when they are too tall and may cause injury if they were to fall unintentionally. Even yet, some barriers may obstruct views in which others have a right. Shade, especially in the summer months, can be a valuable commodity. However, many conventional shade producing barriers such an umbrellas or awnings cover a limited area and may have a number of parts and require a substantial supporting structure.

Thus, there is a need for a privacy and shade producing barrier that is aesthetically pleasing, yet can be easily secured to a supporting structure. The barrier should be of a height that injuries can be limited and/or prevented as well as covering a large area. The present invention and its embodiments meets and exceeds these objectives.

### Review of Related Technology:

U.S. Pat. No. 7,290,552 pertains to a portable awning comprising a flexible shading element, an attachment strap for anchoring the shading element to an existing vertical support structure, and poles for maintaining the shading element at a vertically elevated position with respect to the surface of the ground. The shading element is constructed from a waterproof material such as canvas or nylon and substantially protects a user from overexposure to inclement environmental conditions, including direct sunlight, wind, rain, and snow. The poles and the attachment strap are easily disengaged from the shading element, and the shading element is foldable, thereby providing a portable awning which is easily disassembled in order that it be transported between locations or stored between successive uses.

U.S. Pat. No. 6,796,359 pertains to a portable fence supported awning that includes a flexible sheet mounted on a frame that has a rear frame cross member and two sets of lateral frame members. The two sets of lateral frame members are attached to the fence and can support the awning in various positions to provide the desired cover. The lateral frame members can be pivoted into and the flexible sheet can be folded into a compact state for carrying and storage.

U.S. Patent Application 2004/0089426 pertains to an improvement directed towards the privacy, shade, and aesthetic properties of a rigid barrier fence or wall or an outdoor patio. The preferred embodiment is a screen panel with visual and audio impairment properties that extends upward from the top of a barrier wall and effectively increases the overall wall height. Other embodiments affix a shade or aesthetic combination accessory from a barrier fence or wall, roof, or roof support member.

Various devices are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

Generally, the present invention and its embodiments relate to a portable awning that can be used in a variety of settings. The awning may have any number of support posts or members that enable it to potentially be coupled to an existing structure such as fencing, poles, barriers, and the like. The support posts are preferably circular but may be virtually any shape including both polygonal and non-polygonal configurations. The support posts may have an articulating joint or fixed joint that allows certain adjustments of the awning to be made. Further, length and height adjustments may be able to be made to the components.

In practice, a length of material is adapted to be fit over at least a portion of the support posts thereby creating the protection from exposure to excessive environmental elements such as wind, rain, snow, sunlight, and the like. The length of material has a receiving area which may be a tubular member formed from or attached to the length of material. This enables the material to be slidably engaged to the support posts.

An additional barrier may be used in the event that the first length of material does not provide proper coverage and shielding from the elements. In some embodiments, this barrier hangs down and off of the barrier described above. The additional barrier may comprise a single length of material or may comprise sections of material coupled to one another thereby allowing for flexibility in the usage and blockage by the barrier.

In one embodiment there is an apparatus to enhance the privacy of a given area, the apparatus having at least two support members; a first length of material coupled to and spanning a distance between the at least two support members, wherein the first length of material has a wind barrier comprising at least two layers, wherein the at least two layers comprise the first length of material and a mesh layer.

In another embodiment there is an apparatus to enhance the privacy of a given area, the apparatus having a plurality support members coupled to a supporting structure, wherein each of the plurality of support members has a first section and a second section; a first length of material coupled to and spanning a distance between each first section of each of the plurality of support members, wherein the first length of material has a wind barrier comprising at least two layers, the wind barrier spanning a distance across a portion of the first length of material, wherein the at least two layers comprise the first length of material and a mesh layer.

In yet another embodiment of the present invention there is an apparatus to enhance privacy and protect a given area from the elements, the apparatus having a plurality support members coupled to a supporting structure, wherein each of the plurality of support members has a first section and a second section; a first length of material coupled to and spanning a distance between each first section of each of the plurality of support members, the first length of material being coupled to the first section by a securement mechanism, wherein the first length of material has more than one wind barrier comprising at least two layers, the wind barrier spanning a distance across a portion of the first length of material and capable of being resealable with a resealable mechanism, wherein the at least two layers comprise the first length material and a mesh layer, and wherein the more than one wind barrier is disposed between each of the plurality of support members.

In general, the present invention succeeds in conferring the following, and others not mentioned, benefits and objectives.

It is an object of the present invention to provide an apparatus that increases privacy for a surrounding area.

It is an object of the present invention to provide an apparatus that is capable of limiting wind and blown debris.

It is an object of the present invention to provide an apparatus that is portable and lightweight.

It is an object of the present invention to provide an apparatus that can be used for providing shade to an area.

It is an object of the present invention to provide an apparatus that is capable of withstanding inclement weather conditions.

It is an object of the present invention to provide an apparatus that can selectively permit blown air (i.e. a breeze, wind) to pass therethrough.

It is an object of the present invention to provide an apparatus that has multiple points of securement to create a rigid and safe structure.

### BRIEF DESCRIPTION OF THE DRAWINGS

FIG. 1 is a perspective view of an embodiment of the present invention.

FIG. 2A is a side view of an embodiment of a length of material to be used with the present invention.

FIG. 2B is a side view of an alternate embodiment of a length of material to be used with the present invention.

FIG. 3 is an exploded view of the support system for an embodiment of the present invention.

FIG. 4 is a perspective view of a support system being coupled to a secondary object for support.

FIG. 5 is a front view of an embodiment of the present invention with a resealable opening positioned therethrough.

FIG. 6 is an alternate embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

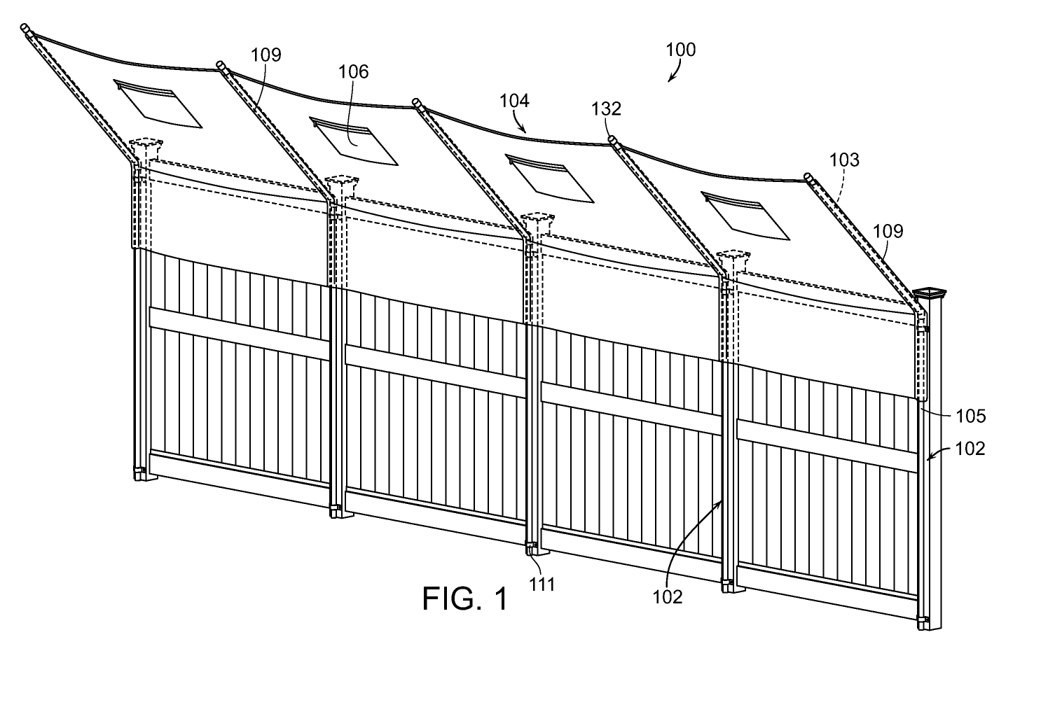

Referring now to FIG. 1, there is a perspective view of an embodiment of the present invention. The apparatus 100 may take the form of a privacy and environmental protection awning that may function as a standalone structure or may be coupled to an existing support structure. The apparatus 100 may comprise at least two support members 102 with a first length of material 104 coupled thereto. In varying embodiments, there may be about two to about one hundred support members depending on the requirements of the user. In other embodiments, the distance between each support member 102 can be the same or different as the distance between any other support member 102.

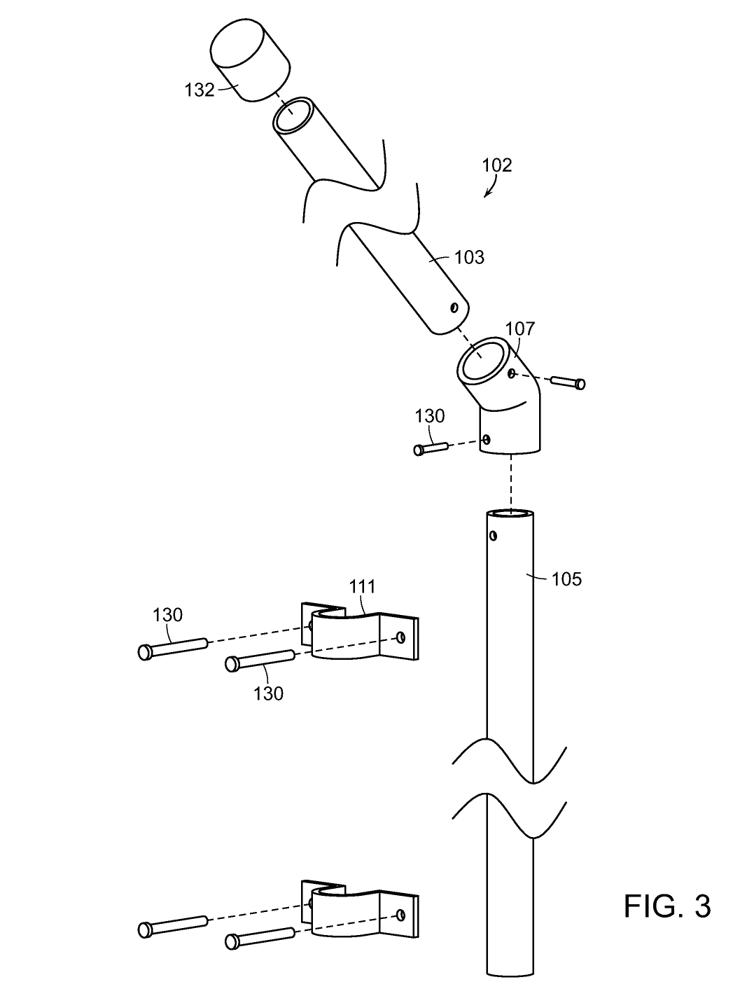

In this particular embodiment, support mechanisms 111 are used to couple the support members 102 to the existing support structure, which may be fencing, as shown in the drawing. In other embodiments the support members 102 may be coupled to fencing poles, fencing boards, concrete barriers, trees, housing and other buildings, and various other temporary and permanent structures or combinations thereof. Various mechanisms of coupling to these structures are further described in FIG. 3. However, in some embodiments, no support structure is required and the present invention may simply be held on or otherwise anchored into the ground surface by various means known in the art.

The support members 102 are generally comprised of a first section 103 and a second section 105, with the first section 103 being coupled to the second section 105. The angle formed between the first section 103 and second section 105 may vary from about 90° to about 180°. In some embodiments, the relative positions of the first section 103 and the second section 105 may be capable of being automatically (i.e. mechanically) or manually manipulated to compensate for factors such as wind, sun, and the like. In other embodiments, the position of the first section 103 and the second section 105 is fixed.

In other embodiments, the support members 102 are height adjustable. Either or both of the first section 103 and the second section 105 may be capable of being extended through the addition of additional lengths coupled thereto, or having telescoping properties to enable varying height/length adjustments. This enables, for example, the first section 103 to be lengthened or shortened to enable more or less protection and privacy. This lengthening/height adjustable feature coupled with the potential angling, as described above, provides a wide range of flexibility to the present invention in terms of adjustability and customizability for the user.

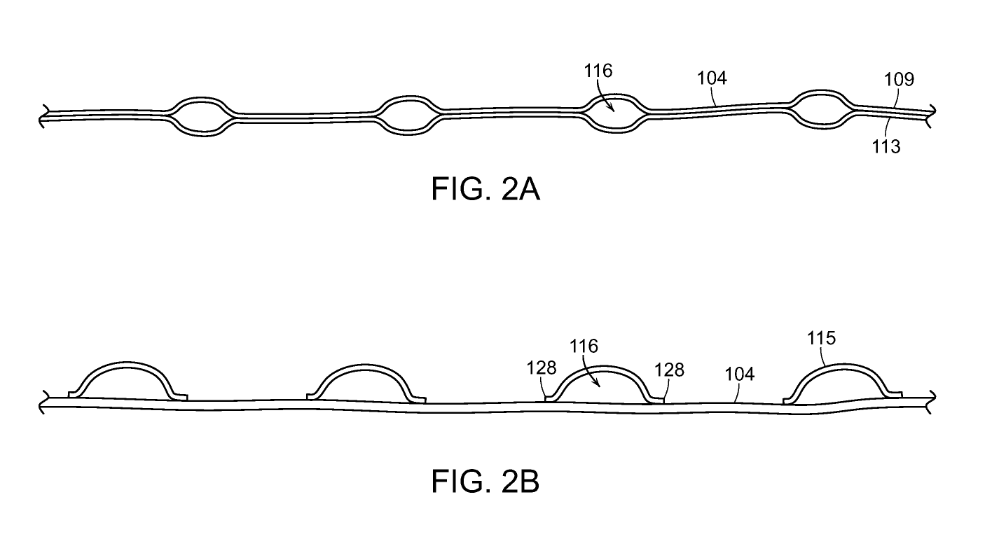

The first length of material 104 is preferably a continuous piece of material that spans a distance between support members 102. The material has receiving areas 116 (see FIGS. 2A and 2B) for receiving the first section 103, second section 105 or a combination thereof. The first length of material 104 may then be secured thereto with at least one securement mechanism 132. The securement mechanism 132 being any mechanism which is capable of retaining the first length of material 104 on the support member 102. In some embodiments, this is a cap, clamp, or the like.

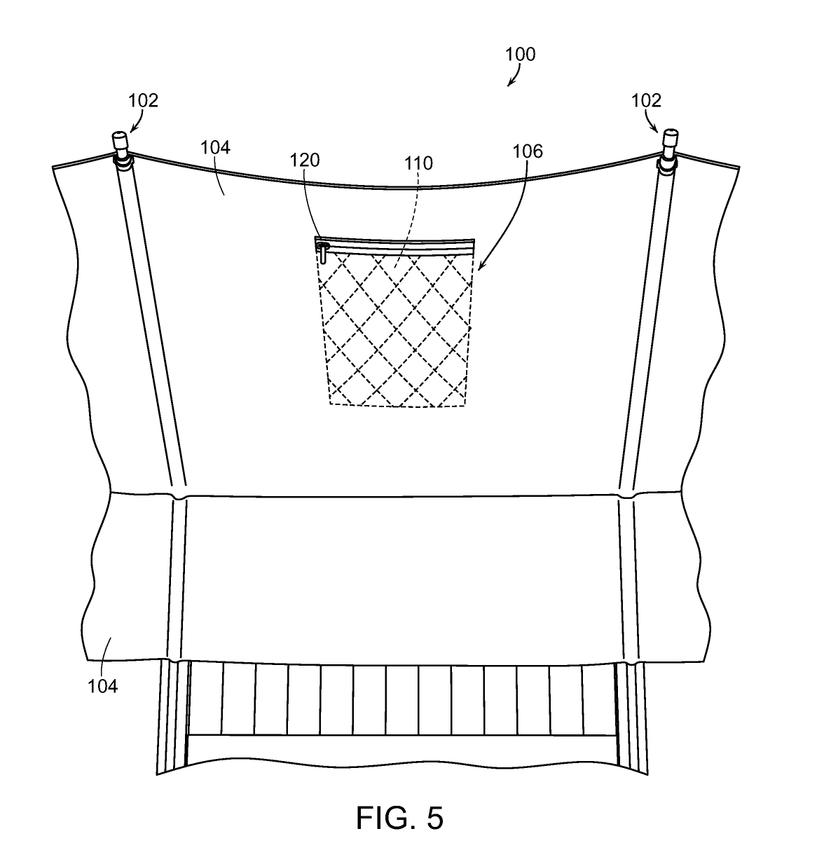

The first length of material 104 may be a wind barrier 106 as described further in FIG. 5. The wind barrier 106 is shown in between each support member 102, however, the exact placement, size, number, and position of the wind barrier(s) 106 may vary. In some embodiments, the first length of material 104 is one piece of material that is disposed over the support members 102. In other embodiments, the first length of material 104 comprises numerous individual pieces which may be coupled or uncoupled as described below. In either case, the distance between the receiving areas 116 (see FIGS. 2A and 2B) may vary throughout the first length of material 104, with any distance being the same or different as any other distance.

Additionally, there may be a fastening mechanism 109 disposed on any of the ends of the first length of material 104. This would allow the first length of material 104 to be separated at this fastening mechanism 109 juncture. In practice, this would allow for the separation of or attachment of varying numbers of sections of the present invention. Thus, a user may desire to have only three sections of the present invention, but later decide a fourth is needed. The use can then simply use the fastening mechanism 109 from one end of the first length of material 104 to the fastening mechanism 109 on another end of the first length of material 104. The user now has four coupled sections of the present invention.

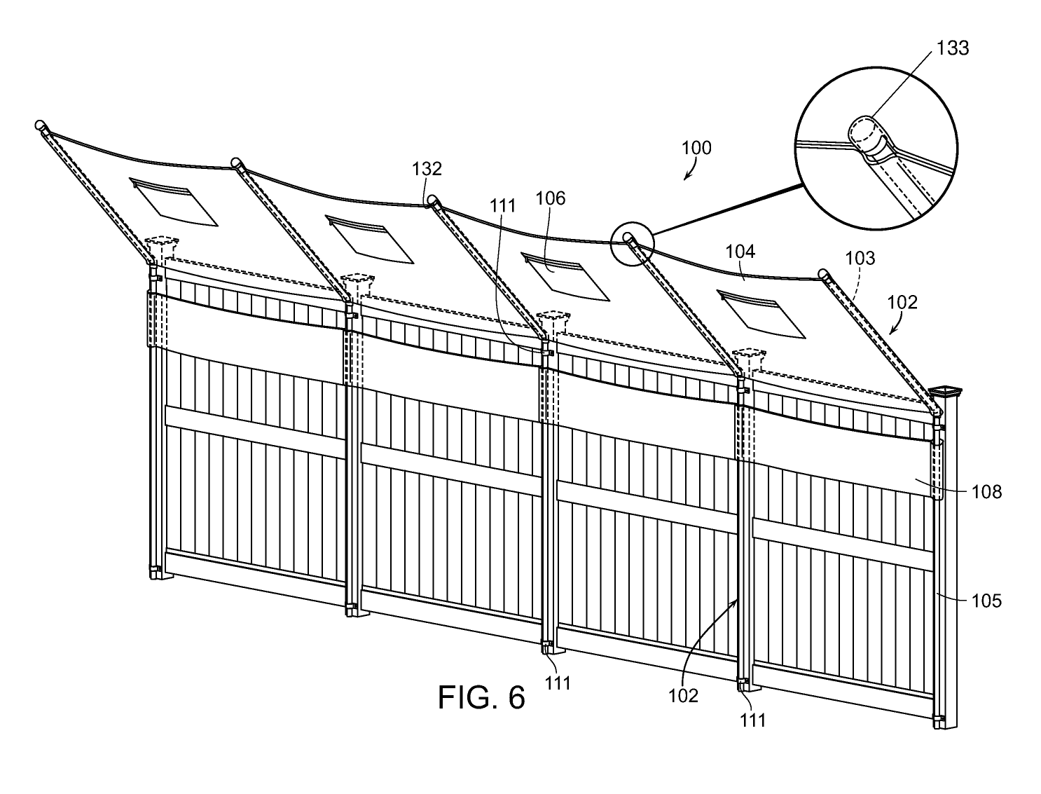

The fastening mechanism 109 may take a number of forms including, but not limited to, zippers, hook and loop fasteners, snaps, buttons, clips, and the like or a combination thereof. In some embodiments, the fastening mechanism 109 may allow for the attachment/detachment of a second length of material 108, as shown in FIG. 6, to the first length of material 104. This may allow for mixing of varying lengths, colors, patterns, designs, and the like or a combination thereof.

In FIGS. 2A and 2B, there are side views of a couple arrangements of the first length of material 104. These are intended to be illustrative only, and other arrangements/compositions of the first length of material 104 may exist.

In FIG. 2A the first length of material 104 is comprised is of a first layer 109 and a second layer 113. The first layer 109 is preferably fused with the second layer 113 forming a single piece of material. At predetermined positions along the first length of material 104 the layers are allowed to remain separate. This creates a receiving area 116 capable of receiving a support member 102 therethrough.

In FIG. 2B the receiving area 116 is formed by a second material 115. The first length of material 104, in this example, is a single layer of material upon which the second material 115 is adhered. The second material 115 is positioned and adhered to the first length of material 104 at connection points 128. The placement of the connection points 128 in conjunction with the length of the second material 115 provides for a receiving area 116 through which a support member may be passed.

FIG. 3 demonstrates an exploded view of an embodiment of a support member 102. The support member 102 has a first section 103, a second section 105, and a joint member 107. Both the first section 103 and the second section 105 may be the same or different in terms of length, width, and other dimensions. Further, the indeterminate length of these components, including the joint member 107, is shown in accordance with the above description of the adjustable length/height of these components. In some embodiments, the first section 103 and the second section 105 have the same or different composition.

The joint member 107 shown is used to define the angle between the first section 103 and the second section 105. The joint member 107 may articulate, in some embodiments, to enable independent adjustment of the angle of a support member 102. Fasteners 130 may be used to securely couple the first section 103, second section 105, and joint member 107. A securement mechanism 132 may be affixed to one end of the support member 102 as previously described.

The support mechanisms 111 may also be capable of receiving a fastener 130 to securely couple the support mechanism 111 to a structure such as a fence as described above. The number and position of the support mechanisms 111 may vary and may be selected depending on the weight and structural strength of the components used in the construction of the apparatus. However, in some instances, the support mechanisms 111 and fasteners 130 are not required as the present invention may not be coupled to a vertical structure but may be anchored or otherwise held and supported by the ground.

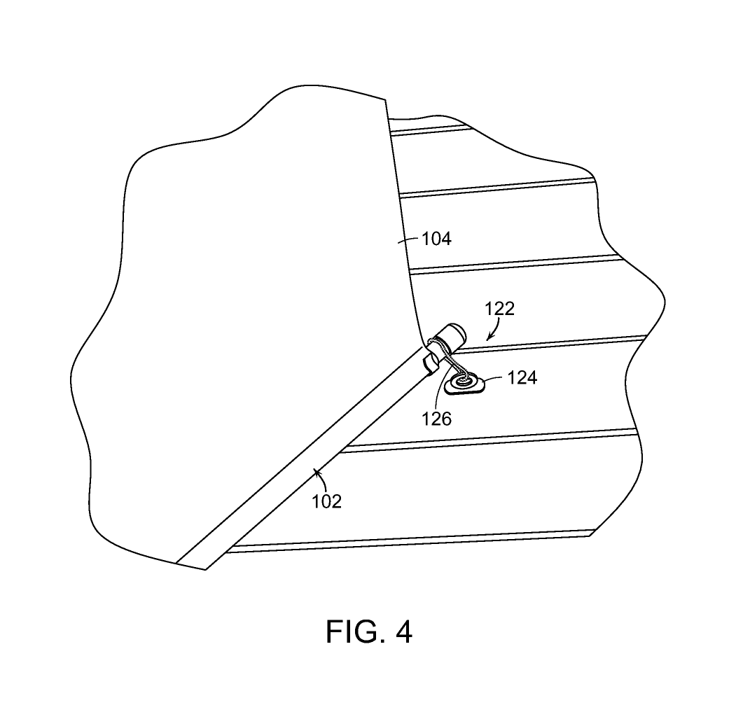

Referring now to FIG. 4, there is another example of a potential securement mechanism. Here, an anchoring mechanism 122 is used to anchor, tether, or otherwise provide support to a free terminal end of the apparatus. The anchoring mechanism 122 may be coupled to an existing structure such as fencing, poles, homes, and the like. An anchoring body 124 is physically coupled to the existing structure and an attachment mechanism 126 extends from the anchoring body 124 to the support member 102. The attachment mechanism 126 is coupled to the support member 102. Thus, the position of the apparatus can be reinforced to prevent damage to the apparatus or an existing structure by preventing torquing of the apparatus. This is particularly helpful when the apparatus is exposed to windy conditions or if the terminal ends of the apparatus receive other outside forces.

In some embodiments, there may be not a suitable structure for use with the anchoring mechanism 122. In such instances, it would be preferable, in some embodiments to have an eyehook or other reinforced opening on the first and/or second length of material. This would allow a line and anchor or other tie down mechanism to be used. In such embodiments, the line may be coupled to the first/second length of material's opening and to the ground, existing supporting structure, or the like or some combination thereof. Such lines and anchoring systems are known in the art and any suitable measure depending on the conditions, weight of the invention, and other considerations that need to be taken into account.

FIG. 5 demonstrates another potential feature of the apparatus 100. Here, there is a close up view of one section of the first length of material 104 situated between support members 102. The first length of material 104 has a wind barrier 106. The wind barrier 106 is a construct designed to allow wind, water, and other elements to pass therethrough. The wind barrier 106 is preferably a mesh material 110 positioned between the layers of the first length of material 104. In other embodiments, the mesh material 110 exists as a section surrounded by the first length of material 104. Still in other embodiments, the wind barrier 106 is a section of mesh material coupled to a front or back side of the first layer of material 104, with the first layer of material 104 have an opening or aperture therein.

A resealable mechanism 120 can be used to selectively allow the wind barrier 106 to be in an open or closed position. When in an open position, an element, such as wind, can be allowed to pass through thereby removing strain placed on the apparatus by the blowing air. An open wind barrier can allow the structure to be placed in a more permanent position without subjecting it to the potential damage from the wind. In another configuration, the wind barrier 106 may be used to let water pass through. Depending on the angle formed by the support member 102, water may pool on a surface of the first length of material 104. By opening the wind barrier 106 the water can be allowed to pass through thereby preventing any accumulated water weight that could damage the apparatus.

In other embodiments, the wind barrier 106 may have varying positions, shapes, and arrangement/composition of components. In some instances, the wind barrier 106 may simply comprise a slit, such as a semi-circular slit, in the first length of material 104. This slit would allow the aforementioned elements to pass through as needed. Such a slit may be a permanent fixture and have no sealing mechanism. In other embodiments, the wind barrier 106 may comprise a mesh material coupled to one side of the first length of material 104. The mesh material may be coupled at least at a first point and second point above and below or on either side of an opening or aperture in the first length of material 104. Such an embodiment would also not require, but could have, a resealable mechanism if so desired. The variations described herein are only intended to be illustrative and it may be apparent to those of skill in the art that various other configurations, materials, and the like may be used and are contained under the purview of this invention.

Referring now to FIG. 6, there is an alternate embodiment of the present invention. Here, the apparatus 100 generally comprises support members 102, first length of material 104, and a second length of material 108. The support members 102 generally have at least a first section 103 and a second section 105. However, in some embodiments, the support member 102 are of unitary construction. The support members 102 are coupled to an existing structure via securement mechanisms 111.

The first length of material 104 has the wind barrier 106 as described in FIG. 5. The wind barrier 106 is shown in between each support member 102, however, the exact placement, size, number, and position of the wind barrier(s) 106 may vary. Further, in this and other embodiments, a second length of material 108 may also be employed. The second length of material 108 is designed to cover gaps or openings in a structure, such as fencing, in addition to the first length of material 104. The second length of material 108 is preferably formed from the same material (compositionally) and in some instances is located below the first length of material 104. The second length of material 108 may also provide privacy but be easier to manipulate as it is a smaller piece of material.

Further, in some embodiments, the first length of material 104 may be supported or held on the support member 102 via a cap/lid member 133. The cap member 133 is preferably a flap of material that rests on a terminal end of the first section 103 of the support member 102 as shown. The cap member 133 may be flipped up or otherwise moved from its position relieving the support provided therefrom to adjust the first length of material 104. Such a cap member 133 may also aid in preventing slippage of the first length of material 104 thereby potentially limiting the maintenance on which a user musty exert in maintaining the apparatus.

For example, the cap members 133 can be removed and the first length of material 104 slid down the length of the first section 103 thereby allowing the first length of material 104 to be retracted. Additionally, this cap member 133 enables this retraction to be accomplished without having to remove the entire apparatus to do so. It is preferable that the securement mechanism 132, in this case a cap, remains over the end of the support member 102 to prevent rain water and other objects from entering an open end of the support member 102.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An apparatus to enhance the privacy of a given area, the apparatus comprising:
at least two support members;
a first length of material coupled to and spanning a distance between the at least two support members,
wherein the first length of material has a wind barrier comprising at least two layers,
wherein the at least two layers comprise the first length of material and a mesh layer.

2. The apparatus of claim 1 further comprising,
a resealable opening traversing a length of the first length of material.

3. The apparatus of claim 1 wherein the at least two support members are comprised of a first section and a second section.

4. The apparatus of claim 3 wherein an angle formed between the first section and the second section is about 90° to about 180°.

5. The apparatus of claim 3 wherein the first section and the second section are removably coupled to one another.

6. The apparatus of claim 5 wherein a joint member receives each of the first section and the second section.

7. An apparatus to enhance the privacy of a given area, the apparatus comprising:
a plurality support members coupled to a supporting structure,
wherein each of the plurality of support members has a first section and a second section;
a first length of material coupled to and spanning a distance between each first section of each of the plurality of support members,
wherein the first length of material has a wind barrier comprising at least two layers, the wind barrier spanning a distance across a portion of the first length of material,
wherein the at least two layers comprise the first length of material and a mesh layer.

8. The apparatus of claim 7 wherein the first length of material has a plurality of receiving areas.

9. The apparatus of claim 8 wherein each the plurality of receiving areas are adapted to receive the first section of the plurality of support members.

10. The apparatus of claim 7 wherein the first section and the second section are circular.

11. The apparatus of claim 7 wherein the wind barrier has a resealable opening capable of letting blown air pass through a portion of the first length of material.

12. The apparatus of claim 7 wherein there is at least one wind barrier between each of the plurality of support members.

13. An apparatus to enhance privacy and protect a given area from the elements, the apparatus comprising:
a plurality support members coupled to a supporting structure,
wherein each of the plurality of support members has a first section and a second section;
a first length of material coupled to and spanning a distance between each first section of each of the plurality of support members, the first length of material being coupled to the first section by a securement mechanism,
wherein the first length of material has more than one wind barrier comprising at least two layers, the wind barrier spanning a distance across a portion of the first length of material and capable of being resealable with a resealable mechanism,
wherein the at least two layers comprise the first length material and a mesh layer, and
wherein the more than one wind barrier is disposed between each of the plurality of support members.

14. The apparatus of claim 13 wherein the first length of material is a continuous piece of material.

15. The apparatus of claim 13 wherein the resealable mechanism is a teeth and groove fastener or a hook and loop fastener or a combination thereof.

16. The apparatus of claim 13 further comprising an anchoring mechanism,
wherein the anchoring mechanism is coupled to a terminal support member thereby providing support for the apparatus.

17. The apparatus of claim 13 further comprising a joint member capable of removably coupling the first section to the second section of each of the plurality of support members.

18. The apparatus 16 wherein the anchoring mechanism comprises an attachment mechanism and an anchoring body with the attachment mechanism being coupled to the terminal support member and the anchoring body,
wherein the anchoring body is coupled to the same or a different supporting structure.

19. The apparatus of claim 13 wherein the first length of material is at least partially disposed over the second section of the plurality of support members.

20. The apparatus of claim 13 further comprising a second length of material disposed below or behind the first length of material,
the second length of material being coupled to the supporting structure to cover gaps in the supporting structure.
